(19) United States
(12) Patent Application Publication
(10) Pub. No.: US 2004/0121817 A1
(43) Pub. Date: Jun. 24, 2004

(54) Mobile communications device

(76) Inventors: Tai Hou Tng, Singapore (SG); Gareth Loudon, South Wales (GB)

Correspondence Address: BURNS DOANE SWECKER & MATHIS L L P, POST OFFICE BOX 1404, ALEXANDRIA, VA, 22313-1404, US

(21) Appl. No.: 10/473,405

(22) PCT Filed: Mar. 20, 2002
(86) PCT No.: PCT/EP02/03134

(30) Foreign Application Priority Data
Apr. 4, 2001 (GB) 0108508.3

(51) Int. Cl. H04M 1/00; H04B 1/38

(52) U.S. Cl. 455/566; 455/575.1

(57) ABSTRACT

There is disclosed a method for entering ideographic characters from a keypad of a mobile communications device such as a mobile phone. Each of the keys in the keypad of the mobile communications device corresponds to a character pattern or structure. On selection by user of one of these patterns, the device presents the user with a selection of possibilities for a first component of the selected pattern. Assuming that the pattern includes more than one component then, on selection by the user of one of the possibilities for the first component, the user is presented with a series of possibilities for a second component, and so on until the character has been composed from the relevant components. Since the pattern of a desired character can be determined relatively unambiguously, it is relatively easy for the user to enter the character correctly.

### TECHNICAL FIELD OF THE INVENTION

This invention relates to a mobile communications device, and in particular to a method of character entry in such a device. More specifically, the invention relates to a method of entry of Chinese characters.

### BACKGROUND OF THE INVENTION

It is convenient for many users of mobile communications devices, such as mobile phones, to be able to enter text using ideographic characters, such as Chinese characters. However, such devices generally have small key pads, for example including keys for each of the digits 0-9, plus a small number of other keys, and typically also have only small displays, for example of the order of a few tens of millimetres in each direction.

Within these constraints, it is difficult to provide a method of character entry for ideographic characters.

CN-1118085A discloses a system which allows Chinese characters to be input using only numeric keys 0-9. This is achieved by allocating to each of the keys a group of characters which have aspects of their pronunciation in common.

WO97/07449 discloses a method for encoding and inputting Chinese characters, in which each character comprises one or more components, every component being mapped to a specific one of the numeric keys 0-9, on the basis of a perceived visual similarity between the character component and one of the Chinese characters representing one of the digits 0-9. The Chinese character can then be input by entering the sequence of digits corresponding to the components of the character. However, this has the disadvantage that the similarities between the character components and the Chinese characters representing the digits 0-9 are often not great, which makes it difficult for the user to determine which digit should represent a specific character.

### SUMMARY OF THE INVENTION

According to the present invention, each of the keys in a key pad of a mobile communications device corresponds to a character structure. On selection by the user of one of these structures, the device presents the user with a selection of possibilities for a first component of a character having the selected structure. Assuming that the structure includes more than one element then, on selection by the user of one of the possibilities for the first component of the character, the user is presented with a series of possibilities for a second component.

This has the advantage that the structure of a desired character can in many cases be determined relatively unambiguously, which means that it is relatively easy for the user to enter the character correctly.

In the case of characters whose structure cannot easily be determined unambiguously, the user can be presented with the required components as possibilities, through more than one structure.

It should be emphasised that the term “comprises/comprising” when used in this specification is taken to specify the presence of stated features integers, steps or components but does not preclude the presence or addition of one or more other features, integers, steps, components or groups thereof.

### BRIEF DESCRIPTION OF DRAWINGS

FIG. 1 shows a mobile phone in accordance with the present invention.

FIG. 2 shows in more detail the keypad of the mobile phone of FIG. 1.

FIG. 3 is a flow chart showing a method of operation of the mobile phone of FIG. 1, in accordance with an aspect of the present invention.

FIGS. 4-8 show in more detail the display of the mobile phone of FIG. 1, at respective stages in the method of operation shown in FIG. 3.

FIG. 9 shows a second method of operation of the mobile phone of FIG. 1, in accordance with an aspect of the present invention.

FIGS. 10-12 show screen displays during the method of FIG. 9.

FIG. 13 shows a third method of operation of the mobile phone of FIG. 1, in accordance with an aspect of the present invention.

FIGS. 14-16 show further screen displays during the method of FIG. 13.

### DETAILED DESCRIPTION OF PREFERRED EMBODIMENT

FIG. 1 is a schematic representation of a mobile phone 2 which is in accordance with the present invention. Although the invention is described herein with reference to a mobile phone, it will be appreciated that the invention is generally applicable to portable radio communication equipment or mobile radio terminals, such as mobile telephones, pagers, communicators, electronic organizers, personal digital assistants (PDAs), or any other equipment in which it is desired to be able to input characters which are selected from a large character set.

As is conventional the mobile phone 2 has an antenna 4, speaker 6, display 8, keypad 10, and microphone 12.

It will be noted that this device is a small, readily portable device, and, as such, has various constraints on the man-machine interface (MMI). For example, the display 8 may typically be of the order of 40 mm×30 mm. The information to be presented to the user on the display in accordance with the invention will be described in more detail below. Similarly, the keypad 10 includes numeric keys 0-9, plus a relatively small number of other keys. Again, the use of these keys in accordance with the invention will be described in more detail below.

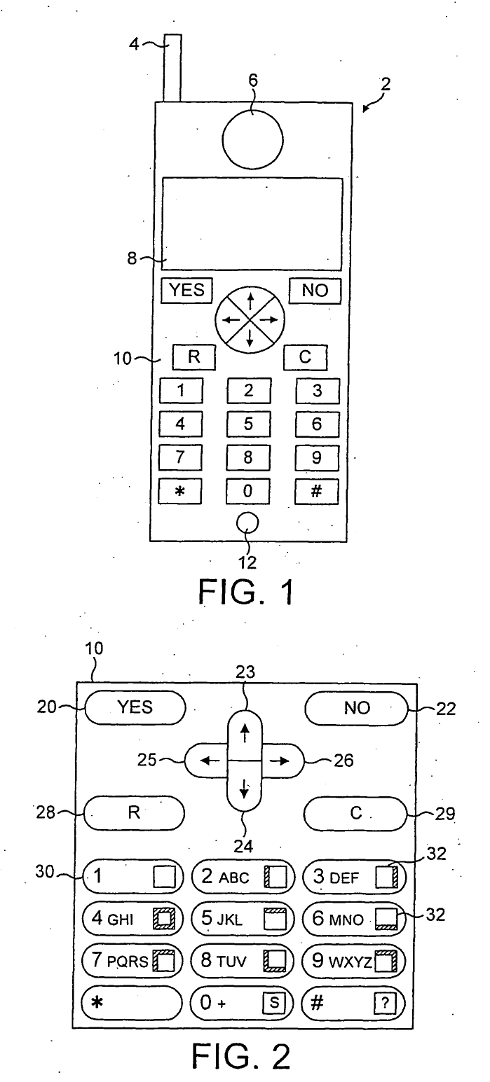

FIG. 2 shows the key pad 10 of the mobile phone 2 in more detail. As it is conventional, the phone includes a YES key 20 and a NO key 22. These have their normal functions and, when the phone is in a mode of operation in which ideographic characters are being entered, also have additional functions as described below. Similarly, the phone has UP, DOWN, LEFT and RIGHT buttons 23, 24, 25, 26 respectively. Again, these have their conventional functions, but also have additional functions as described further herein, when the phone is in a mode in which ideographic characters are being entered.

Further, the key pad includes a recording R key 28 and a clear C key 29, the functions of which will be described further below.

Finally, the key pad 10 includes “numeric” keys 30, comprising 10 digit keys 0-9, * and #. Digit keys 2-9 can also be used for inputting letters of the English alphabet, as shown on the respective keys. Thus, the “2” key can be used for inputting letters A, B or C, for example. Again, these functions of the numeric keys 30 are conventional, but the keys also have other functions when inputting ideographic characters, as will be described further below.

Specifically, each of the digit keys 0-9, and the # key also includes a respective square box 32, which indicates the function of that key in connection with inputting ideographic characters.

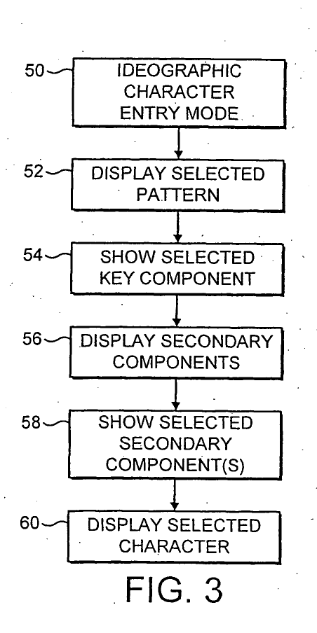

FIG. 3 is a flow chart which describes a method of inputting an ideographic character sequence in accordance with an aspect of the present invention.

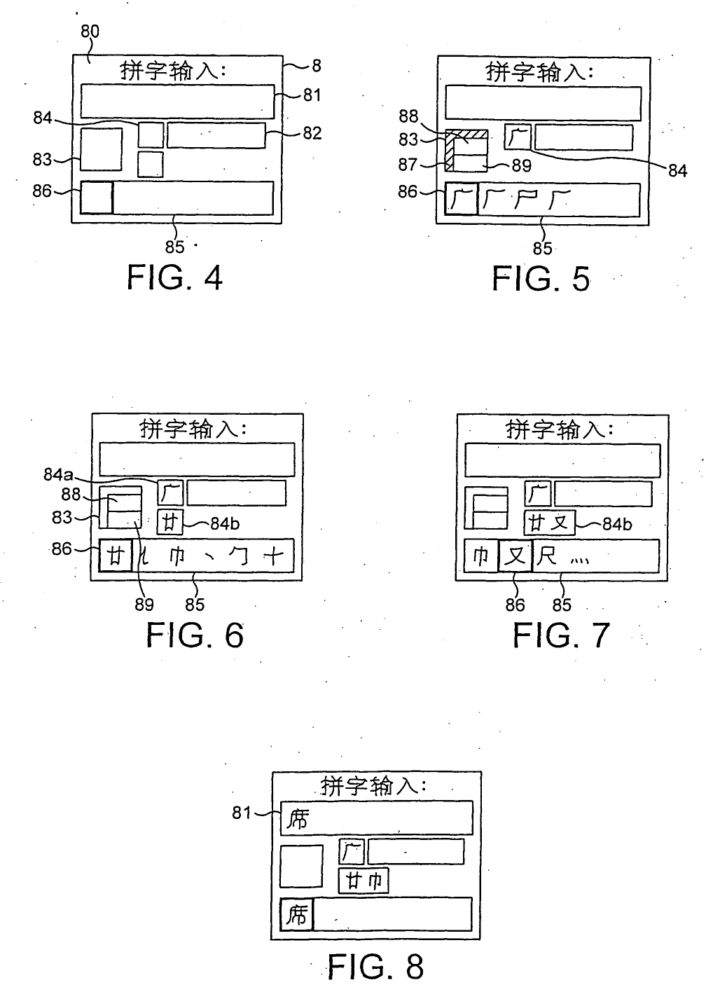

The method illustrated in FIG. 3 will also be illustrated in more detail with reference to FIGS. 4-8, which show the displays on the screen 8, at different stages in the method.

To begin a process, the user puts the phone into is an ideographic character input mode (step 50 in FIG. 3). This may be done, for example, by selecting this mode from a menu of features, in a generally conventional way.

FIG. 4 shows the display 8 of the phone, when it is in this mode. The display includes a first region 80, containing text indicating that the phone is in the ideographic character input mode.

The display further includes a second region 81, which is a box displaying a composed passage of output text. Further, the display includes a second box 82, indicating a further subdivision of the mode of operation. Specifically, this may indicate the type of characters being input. For example, the phone may have different modes of operation, each in accordance with the present invention, for inputting Simplified Chinese, Traditional Chinese, Japanese or Korean CJK ideographs.

In accordance with invention, characters are selected based on their structure. The display therefore includes a box 83, which indicates the current selected character structure.

Further, the display includes a box 84, for containing the components of a current character being input.

Finally, the display includes a further box 85, displaying a candidate list of components which can be selected as part of a current character being input. A square 86, which may advantageously be in a specific colour in a multi-coloured display, is movable along the candidate list in box 85 by means of the LEFT and RIGHT keys 25, 26, allowing the user to select from amongst the presented candidates.

As mentioned previously, aspects of the present invention relate to the inputting of ideographs, on the basis of their grouping into patterns or structures. Thus, each of the digit, keys 0-9 includes a region 32, which shows a pictorial representation of a structure. Therefore, depending on the structure of the character which he wishes to input, the user can press one of the digit keys 0-9. The meanings of these keys are set out in the table below.

| Key | |
|---|---|
| 1 | Singular structure |
| 2 | Left-right structure with left component as key |
| | component |
| 3 | Left-right structure with right component as key |
| | component |
| 4 | Surrounding structure with outside component as |
| | key component |
| 5 | Up-down structure with upper component as key |
| | component |
| 6 | Up-down structure with lower component as key |
| | component |
| 7 | Upper left surrounding structure with upper left |
| | component as key component |
| 8 | Lower left surrounding structure with lower left |
| | component as key component |
| 9 | Upper right surrounding structure with upper |
| | right component as key component |
| 0 | Symbols |

It will be noted that each of the keys 2-9 defines a key component of the structure, which is shown shaded in the respective pictorial representation in the respective region 32 of the relevant key. Each of these structures has a group of sub-structures related to it, depending upon the number of secondary components.

Thus, the “2” key is used to input characters which have a LEFT-RIGHT structure, that is a pattern in which the character can be divided into left and right halves, and in which the component on the left can be regarded as the most important component. In this case, there may be a single component in the right half of the structure, or there may be more than one such component. By pressing the “2” key once, the user selects a sub-structure with one element on the left side and one element on the right side; by pressing the “2” key twice, the user selects a sub-structure with one element on the left side and two elements on the right side; by pressing the “2” key three times, the user selects a sub-structure which has one element on the left side and three elements on the right side; and by pressing the “2” key four times, the user selects a sub-structure which has one element on the left side and four elements on the right side; all of these sub-structures having the same basic structure, namely a left-right structure, with the key element on the left side.

Each of the keys 2-9 may be pressed from one to four times, to define patterns in a similar way, with a single key element, as defined in the table above, and a number of secondary elements which corresponds to the number of key presses. It should be noted that the structure which is defined in this way does not specify anything about the relative positions of the secondary elements. Thus, for example, in the case of a structure with one key element on the left side and two secondary elements on the right side, the secondary elements can be positioned one above the other or side by side.

In the case of the digit keys 1 and 0, the position is slightly different. The digit key “1” represents a number of different categories of characters which have unitary structures, as described in the table below.

| | Number of | |
|---|---|---|
| Key | presses | Meaning |
| 1 | 1 | Chinese character |
| 1 | 2 | All Chinese BoPoMoFo Ideographs |
| 1 | 3 | All Japanese Hiragana Ideographs |
| 1 | 4 | All Japanese Katakana Ideographs |

Thus, pressing the “1” key an appropriate number of times, allows the user to select a character from the selected character set.

Similarly, the digit key “0” represents a number of different categories of characters, as set out in the table below.

| | Number of | |
|---|---|---|
| Key | presses | Meaning |
| 0 | 1 | Numeric symbols |
| 0 | 2 | CJK and Western Punctuation Marks |
| 0 | 3 | Lower case English letters |
| 0 | 4 | Upper case English letters |

Again, pressing the “0” key an appropriate number of times allows the user to select a character from the appropriate character set.

It will be noted that pressing the “0” key either three or four times allows the user to select an English letter, which may sometimes be required when entering a character string which is generally in an ideographic character set. Where the user wishes to enter a longer text composed mainly or entirely of English letters, this can be done more conveniently by entering a different character entry mode.

It will be apparent that, although there has been described one preferred way of allocating different character structures amongst the numeric keys of the keypad, many other such arrangements are possible. For example, sub-structures which are accessed by pressing the same key different numbers of times in the arrangement described above, could instead be allocated to different keys.

When the user has selected the desired structure, for the character which is to be entered, this is displayed on the screen, in the box 83 of the display 8. For example, in the case where the user presses the “7” key twice, it is determined that the character to be input has an upper left surrounding structure, with the upper left component of the character as the key component, and with two secondary components. The box 83 on the display 8 therefore contains an outline of the selected structure, in which the shape of the key element on the upper left is preferably displayed in a different colour, which indicates that it is the first component to be entered, and which shows two secondary elements.

At the same time, the box 85 contains a list of possible components, which can be the upper left component in characters of the selected structure, from the desired character set.

Advantageously, the possible components are presented in an order which corresponds to their frequency of occurrence, thereby making the selection easier for the user.

The user can select one of these components by moving the box 86 along the list by using the LEFT and RIGHT keys 25, 26. At that stage, as shown in FIG. 5, the box 83 shows the selected pattern, with the highlighted upper left component 87, and two secondary components 88, 89. The box 85 contains the list of candidate key components, with the moveable box 86 containing the presently selected component. The presently selected key component in the box 86 is also displayed in the selected key component box 84.

When he reaches the desired component, the user presses the YES key 20 to select that component. After the YES key has been pressed, the screen display then shows the candidates for the secondary components, at step 56 in the process of FIG. 3. Again, the possible components are advantageously presented in an order which corresponds to their frequency of occurrence, thereby making the selection easier for the user.

Thus, as shown in FIG. 6, the box 85 now contains a list of components which can be secondary components in characters in which the key component is the one selected previously. In the box 83, the regions 88, 89, which indicate the secondary components, are preferably now highlighted in a different colour, to indicate that it is the secondary components which are to be selected next.

An upper part 84a of the box 84 indicates the selected key component, while the component presently in the movable box 86 is displayed in the secondary components region 84b of the selected components box 84, as indicated at step 58 in FIG. 3.

When one of the available secondary components is selected, by pressing the YES Key, steps 56 and 58 are then repeated as often as necessary, depending upon the number of secondary components to be entered.

FIG. 7 shows the screen display when a second secondary component is being selected. Thus, the secondary components region 84b of the selected components box 84 contains (on the left) the first secondary component which has been selected, and (on the right) the component presently in the movable box 86.

When the input of the specified number of secondary components is confirmed then, at step 60 in the process of FIG. 3 and as shown in FIG. 8, the character which has been composed is displayed in the output text display box 81 of the display 8. The most recently composed character may be deleted by pressing the NO key 22.

At any time, the composed passage of text, displayed in the output text display box 81 may be recorded in the memory of the phone by pressing the recording R button 28, or may be deleted by pressing the clear C button 29.

The system in accordance with the present invention also allows a user to input characters when She is unsure of the required inputs.

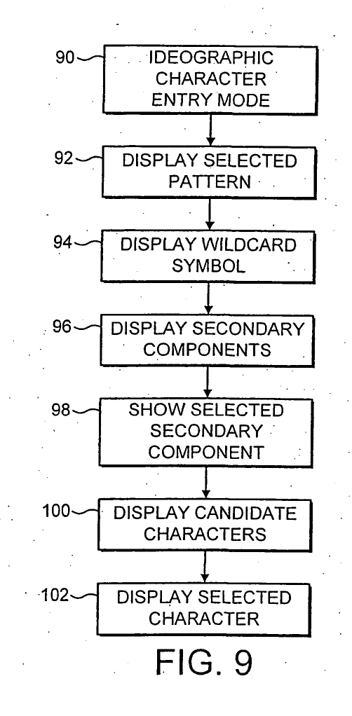

FIG. 9 is a flow chart which shows a procedure which allows the user to input an ideographic character, in accordance with an aspect of the present invention, when he is unsure of one of the components of the character.

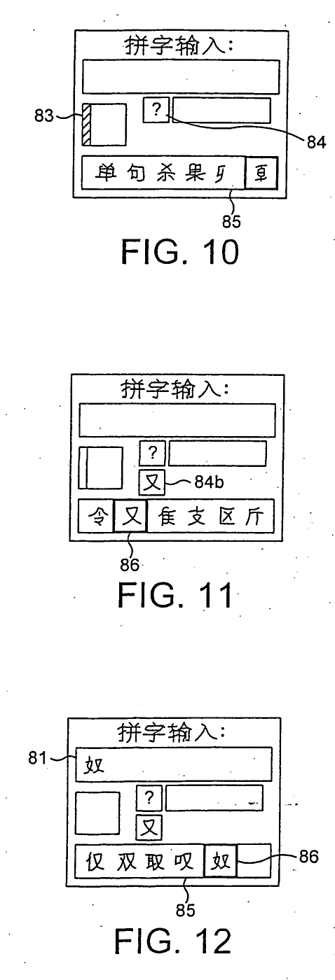

The method illustrated in FIG. 9 will also be illustrated in more detail with reference to FIGS. 10-12, which show the displays on the screen 8, at different stages in the method.

To begin the process, the user puts the phone into an ideographic character input mode (step 90 in FIG. 9).

When the user has selected the desired pattern, for the character which is to be entered, this is displayed on the screen, in the box 83 of the display 8. For example, in the case where the user presses the “2” key twice, it is determined that the character to be input has a left-right structure, with the left component as the key component, and with two secondary components. The box 83 on the display 8 therefore contains an outline of the selected pattern, in which the shape of the key component is preferably displayed in a different colour, which indicates that it is the first component to be entered (step 92 in FIG. 9).

At the same time, the box 85 contains a list of possible components, which can be the left component in characters of the selected structure, from the desired character set.

In this case, the user is unsure which of the candidate components is the correct one for the character which he wishes to enter.

According to this aspect of the invention, the user is able to overcome this by pressing the # key which acts as a wildcard. At that stage, as shown in FIG. 10 and at step 94 in FIG. 9, the box 83 shows the selected pattern, while the box 84 contains a “?”, indicating that no key component has been selected.

Then, in step 96, there is displayed in box 85 a list of all of the components which can be secondary components in the selected pattern.

When the component presently in the movable box 86 is selected, by pressing the YES key, this is then also displayed in the secondary components region 84b of the selected components box 84, as indicated at step 98 in is FIG. 9, and as shown in FIG. 11.

As indicated at step 100 of FIG. 9, the box 85 then displays a list of characters having the selected pattern, in which the secondary component is the selected one.

As shown in FIG. 12, and indicated at step 102 of FIG. 9, one of these characters can be selected by moving the box 86 along the list in the box 85, and pressing the YES key. The character which has been selected is then displayed in the output text display box 81 of the display 8.

Thus, the user is able to compose a character even though he does not know all of the components thereof. The wildcard entry character # can be used for key components and/or secondary components, and there is no limit to the number of times the wildcard entry character # can be used in a character. If the user uses the wildcard entry character # for every component of a character, then all of the characters having the selected pattern can be displayed in the box 85.

The system in accordance with the present invention also allows a user to input a character when he is unsure of the structure thereof.

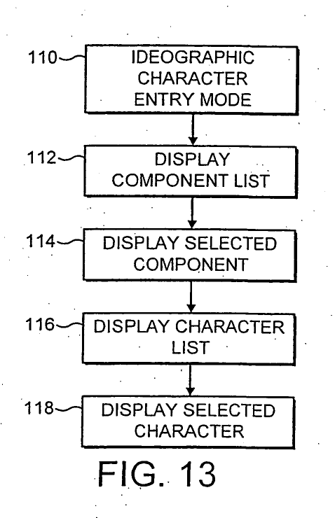

FIG. 13 is a flow chart which shows a procedure which allows the user to input an ideographic character, in accordance with an aspect of the present invention, when he is unsure of the structure of the character.

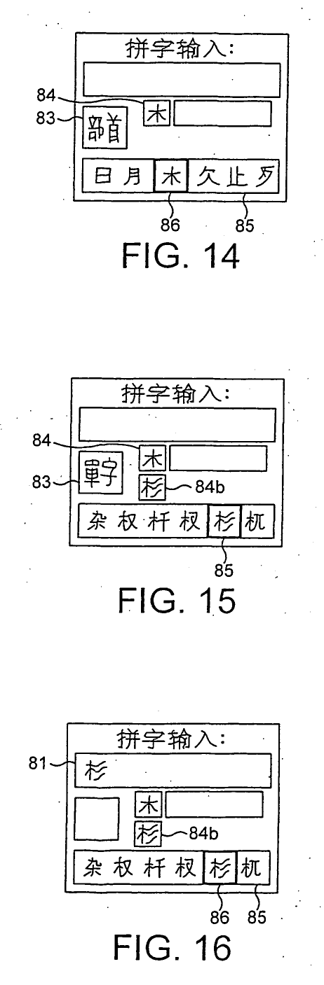

The method illustrated in FIG. 13 will also be illustrated in more detail with reference to FIGS. 14, 15 and 16, which show the displays on the screen 8, at different stages in the method.

To begin the process, the user puts the phone into an ideographic character input mode (step 110 in FIG. 13).

In this example, the user is unable to select the appropriate pattern, and so he presses the * key. In response, in step 112 in FIG. 13, the display shows a character in box 83 which means “radical” or “key component”, to indicate to the user that a selection of a key component is required. The display further includes in box 85 a list of all of the components which may be selected, as shown in FIG. 14. Again, this list advantageously displays the components in an order corresponding to their frequency of occurrence, since there are many such components, and the user may have to scroll through hundreds or thousands of components.

When the user has selected a component, by moving the box 86 along the list, then, as shown in FIG. 15 and in steps 114 and 116 of FIG. 13, the selected component is shown in box 84, and the box 85 displays a list of characters which include the selected component, while the box 83 contains a character meaning “single character”, indicating to the user that the characters shown in box 85 are those available for selection.

One of these characters can be selected by moving the box 86 along the list in the box 85, and pressing the YES key. While the selection box 86 is being moved along the list in box 85, the character which is temporarily in the selection box 86 is shown in the secondary components region 84b of the box 84. Then, when a character is selected, it is displayed in the output text display box 81 of the display 8, as shown in FIG. 16, and indicated at step 118 of FIG. 13.

Thus, the user is able to compose a character even though he does not know its structure. However, to minimise the need for this option, all characters which have ambiguous structures can advantageously be accessed through either of the possible structures.

There is therefore described a method for allowing entry of ideographic characters, using a reduced keypad.

1. A mobile communications device, having a keypad comprising a plurality of keys and a display,
wherein each of the keys corresponds to a character structure comprising one or more elements,
wherein, when the device is in a character entry mode of operation:
when a user presses a key, the display presents a character structure corresponding to the pressed key, and presents at least one option for a first component of a character having the presented character structure;
when a user selects a first component, if the presented character structure comprises more than one element, the display presents at least one option for a second component of a character having the presented character structure which is compatible with the selected first component.

2. A mobile communications device as claimed in claim 1, wherein, when a user selects a second component, if the presented character structure comprises more than two elements, the display presents at least one option for a third component of a character having the presented character structure which is compatible with the selected first and second components.

3. A mobile communications device as claimed in claim 1 or 2, wherein, when a user has selected components for all of the elements of the presented character pattern, a character is entered.

4. A mobile communications device as claimed in claim 1, wherein a presented character structure is displayed in a first region of the display, and a presented option for a component is displayed in a second region of the display.

5. A mobile communications device as claimed in claim 4, wherein, when a user has selected components for all of the elements of the presented character pattern, a character is entered, and wherein entered characters are displayed in a third region of the display.

6. A mobile communications device as claimed in any preceding claim wherein the keys are digit keys.

7. A mobile communications device as claimed in any preceding claim wherein each of the keys corresponds to a character structure including a plurality of related sub-structures,
wherein, when the device is in a character entry mode of operation:
when a user presses a key, the display presents a sub-structure which depends on a number of times that the key was pressed.

8. A mobile communications device as claimed in any preceding claim, having a plurality of character entry modes, corresponding to different types of CJK ideographs.

9. A mobile communications device as claimed in any preceding claim, comprising at least one key for navigating through a list of presented options for character component.

10. A mobile communications device as claimed in claim 9, comprising first and second arrow keys for navigating forwards and backwards respectively through the list of presented options.

11. A method of character entry, for use in a mobile communications device having a keypad comprising a plurality of keys and a display,
the method comprising, when the device is in a character entry mode of operation:
presenting on the display a character structure corresponding to a key pressed by a user, and presenting at least one option for a first component of a character having the presented character structure; and
if the presented character structure comprises more than one element, further comprising, in response to a user selection of the first component:
presenting at least one option for a second component of a character having the presented character structure which is compatible with the selected first component.

12. A method of character entry as claimed in claim 11, further comprising, when a user selects a second component, if the presented character structure comprises more than two elements, presenting at least one option for a third component of a character having the presented character structure which is compatible with the selected first and second components.

13. A method of character entry as claimed in claim 11 or 12, further comprising accepting a character entry when a user has selected all of the components of the presented character structure.

14. A method of character entry as claimed in claim 11, comprising:
displaying a presented character structure in a first region of the display, and
displaying a presented option for a component in a second region of the display.

15. A mobile communications device as claimed in claim 14, further comprising:
accepting a character entry when a user has selected all of the components of a character having the presented character pattern, and
displaying entered characters in a third region of the display.

16. A method of character entry as claimed in any of claims 11-15, wherein the keys are digit keys.

17. A method of character entry as claimed in any of claims 11-16, wherein each of the keys corresponds to a character structure including a plurality of related sub-structures,
the method comprising, when the device is in a character entry mode of operation:
presenting a sub-structure which depends on a number of times that the key was pressed.
